(19) United States
(12) Patent Application Publication
(10) Pub. No.: US 2003/0101878 A1
(43) Pub. Date: Jun. 5, 2003

(54) Hinged plate assembly for holding and slicing a food item

(76) Inventor: Christopher K. Muldoon, South Euclid, OH (US)

Correspondence Address: Patrick R. Roche, Fay, Sharpe, Fagan, Minnich & McKee, LLP, 7th Floor, 1100 Superior Avenue, Cleveland, OH, 44114-2518, US

(21) Appl. No.: 10/280,930

(22) Filed: Oct. 25, 2002

Related U.S. Application Data
(60) Provisional application No. 60/350,765, filed on Oct. 25, 2001.

(51) Int. Cl. A47J 37/10

(52) U.S. Cl. 99/422; 99/425

(57) ABSTRACT

A hinged plate assembly particularly useful for holding a sliced food item, such as a bagel, wherein the food item can be sliced, spread and served. The, assembly comprises two half shells or discs which hold the food item when in a relative closed position as the half shells are disposed to act as a slicing guide for a slicing tool. The hinge assembly comprises a pivot pin and pivot pin holding slot which are configured to allow for attachment and removal of the pin from the holding slot at preselected positions for detaching the half shells from each other for use as independent plates.

This application claims priority to U.S. Provisional Patent Application Serial No. 60/350,765 filed Oct. 25, 2001.

### BACKGROUND OF THE INVENTION

The invention relates to the fields of domestic and commercial food utensils and primarily those that facilitate a safe slicing of a bread item, such as a bagel. The food item may be hot or cold. The assembly is also intended to be used as a detachable plate assembly for holding distinct parts of the sliced food item.

A bagel is a popular food item and is purchased and consumed not only for domestic use but in a wide variety of commercial establishments, particularly as a staple of breakfast. Most bagels are prepared and baked as a unitary item having a generally hard outer shell. Applying a spread, such as cream cheese, jelly or butter, to the bagel is a very popular form of ultimate preparation before consumption. A sharp slicing tool, such as a knife, is typically employed to slice the bagel in half to expose the softer inner portions of the bagel which allow for better reception and more even spreading of the desired spread. The cutting is usually done along the cross-sectional dimension of the bagel to expose a greater surface area of the inner portions of the bagel. Such a slice can be difficult and dangerous when merely performed as a hand-held operation, and even more so when the bagel is still hot or toasted.

Particularly in commercial establishments, the immediate handling of purchased bagels for consumption also presents a sanitary problem where a large number of customers frequent common areas and the bagels are all hand-handled, except for simple paper plates or napkins. A better, more secure, washable plateware would enhance the sanitary and safe handling of the bagels.

Accordingly, there is a need for a bagel handling product which can cleanly and safely be used to hold the bagel for the desired slicing operation, but can also be used as plateware for facilitating spreading a spread over the sliced bagel, or for even holding the bagel during consumption.

The subject invention is intended to overcome these problems and others to provide an improved food-handling product.

### SUMMARY OF THE INVENTION

It is a feature of the invention to provide a hinged plate assembly for holding a sliceable food item, such as a bagel, in a selected position to facilitate a safe slicing operation. The assembly comprises first and second half shells comprising holding areas for the food item, each respectively including portions of a detachable hinge assembly to allow the half shells to pivot relative to one another for opening and closing on the food item. The hinge assembly includes a pivot pin holding slot associated with the first half shell and a pivot pin associated with the second half shell. The first pin holding slot is dimensioned to selectively receive or remove the pivot pin from the pivot pin holding slot, wherein the pin may rotate in the holding slot through at least one hundred eighty degrees of rotation for effectively closing the first and second half shells to a first position to hold the food item, and opening the first and second half shells to a second position wherein the half shells may be relatively flat as adjacent plates, each holding a part of the sliced food item. In the first and second positions the pivot pin is locked within the pivot pin holding area to preclude detachment of the half shells from each other. To selectively remove the pivot pin from the pivot pin holding slot, thereby allowing detachment of the half shells, the half shells may be relatively rotated to a preselected position wherein the pivot pin may be removed from the pivot pin holding area.

In accordance with a more limited feature of the present invention, the pivot pin has an axis of rotation disposed relative to the half shells to define a spacing between the half shells to accommodate a slicing tool when closed to the first position. Accordingly, it is intended in a preferred embodiment that the plate assembly have a holding area sized to be smaller than the volume of the contained bagel so that the bagel may hold the half shells apart from each other to define the spacing area to accommodate the slicing tool.

In accordance with a more limited aspect of the present invention, the pivot pin comprises a projection having a long side and a short side. The long side is dimensioned to hold the pivot pin within the pivot pin holding area in the degrees of rotation corresponding to other than the preselected position of detachment. The short side is dimensioned to allow the pivot pin to slide out of the pivot pin holding area when the degree of rotation corresponds to the preselected position.

It is one benefit of the invention to provide a caddy for a food item, such as a bagel, that facilitates cutting of the bagel, applying a spread to the sliced bagel by better holding the bagel within the caddy, and lastly, functioning as either associated or detachable plates as plateware for the sliced and spread bagel half.

As another benefit of the present invention, the subject bagel caddy provides half shell plates which are readily detachable when disposed in a particular relative position, but remain locked and attached at other relative positions.

These and other benefits will be appreciated by those of ordinary skill of the art upon a reading and understanding of the specification of the invention.

### BRIEF DESCRIPTION OF THE DRAWINGS

FIG. 1 is a perspective view of the hinged plate assembly of the present invention.

FIG. 2 is a top planar view of the assembly in a closed position.

FIG. 3 is a side cross-sectional view of the invention taken along the plane A-A of FIG. 2.

FIG. 4 is a side view showing the half shell plates at ninety degrees relative rotation.

FIG. 5 is a cross-sectional view through a pivot pin showing the assembly at one hundred eighty degrees relative rotation.

FIG. 6 is a top planar view of one of the half shells of plates of the assembly in a detached position from the other half shell plate.

FIG. 7 is a cross-sectional view of the half shell of FIG. 6 taken along plane A-A for particularly illustrating the pivot pin configuration.

FIG. 8 is a planar view of the other half shell.

FIG. 9 is a side planar view of the half shell of FIG. 8 particularly illustrating the pivot pin holding slot portion of the half shell.

### DETAILED DESCRIPTION OF THE PREFERRED EMBODIMENTS

The hinged plate assembly 10 of the present invention is intended for holding a sliceable food item, such as a bagel, in a selected position to facilitate a safe slicing operation of the bagel. The assembly comprises opposed discs such as a first half shell or plate 12 comprising a first holding area for the food item and a first portion of the hinge assembly 14 including a pivot pin holding slot 16 disposed therein. The second half shell 20 comprises a second holding area 21 for the food item and a second portion 22 of the hinge assembly 14 including a pivot pin 24 disposed therein.

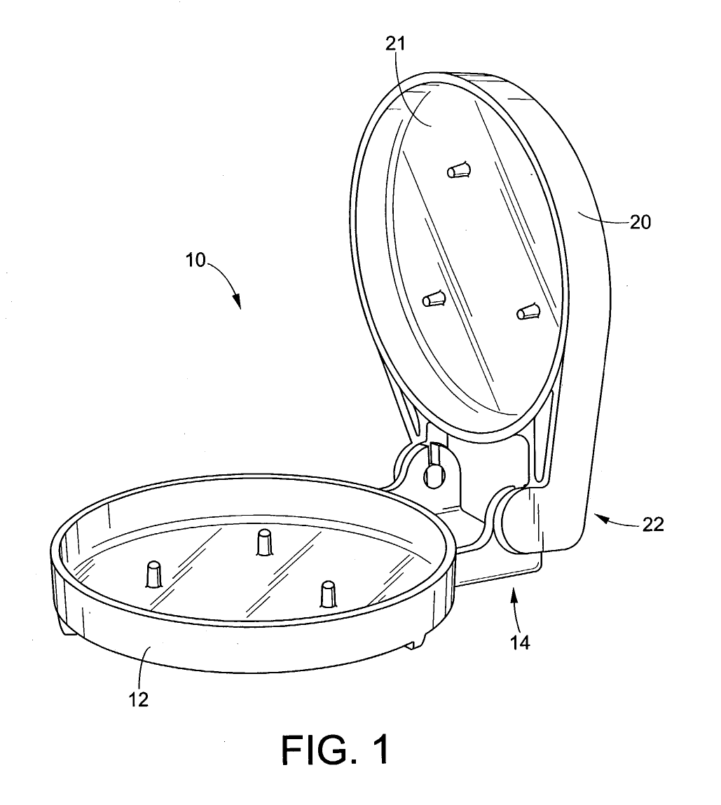

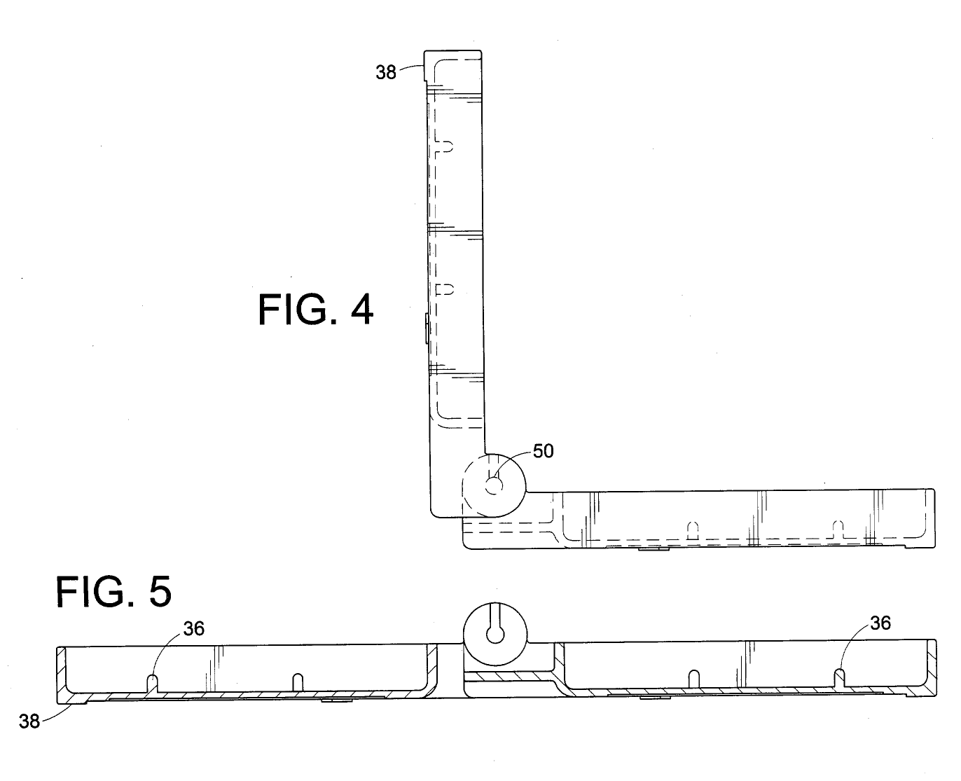

With particular reference to FIGS. 1, 8 and 9, the pivot pin holding slot 16 is dimensioned to selectively receive or remove the pivot pin 24 from the pivot pin holding slot so that the pin may rotate in the holding slot through at least one hundred eighty degrees of rotation for effectively closing the first and second half shells 12, 20 to a first position (FIG. 3) to hold the bagel, and opening the first and second half shells to a second position (FIG. 5) wherein the half shells may be relatively flat as adjacent plates to one another, each holding a part of the sliced bagel. The first and second positions comprise a locked holding of the pivot pin 24 within the pivot pin holding area 16 which is particularly important at the first position for a safer slicing operation. To selectively detach the half shell plates from one another, the pivot pin 24 must be removed from the holding area 16. As will be seen in more detail below, the pin is rotated to a preselected position (FIG. 4) wherein the pivot pin may be removed from the pivot pin holding area.

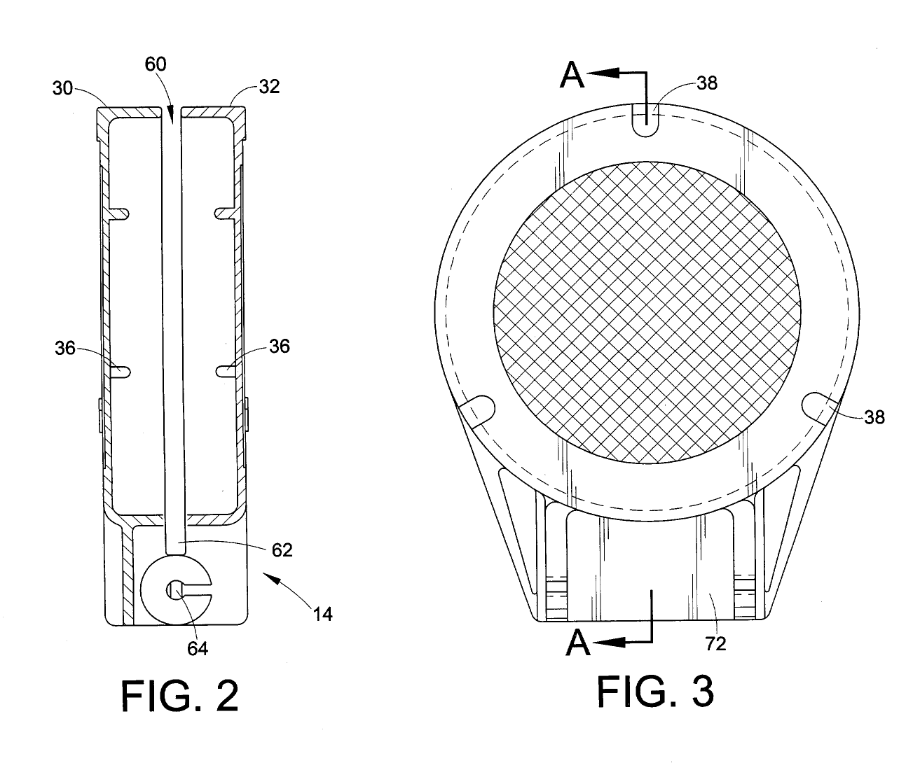

The Figures show that the half shells preferably comprise cupped configurations having side walls 30, 32 to better contain and secure the food item within the assembly either at the closed position of FIG. 3 or the flat position of FIG. 5. A plurality of projecting prongs 36 are disposed within each of the half shells to grip and secure the food item within the assembly. The inner prongs 36 effectively stabilize the bagel, particularly for the slicing operation. Support tabs 38 (FIG. 2) are disposed on the top and bottom walls of the assembly 10 to function as support legs to provide a level or flat plate surface when the caddy is laid flat as in FIG. 5.

It is particular feature of the invention that the hinge assembly allows for attached rotation of the half shells for most of the relative degrees of rotation, but allows detachment at a particular position so that the half shells may be used as independent plates.

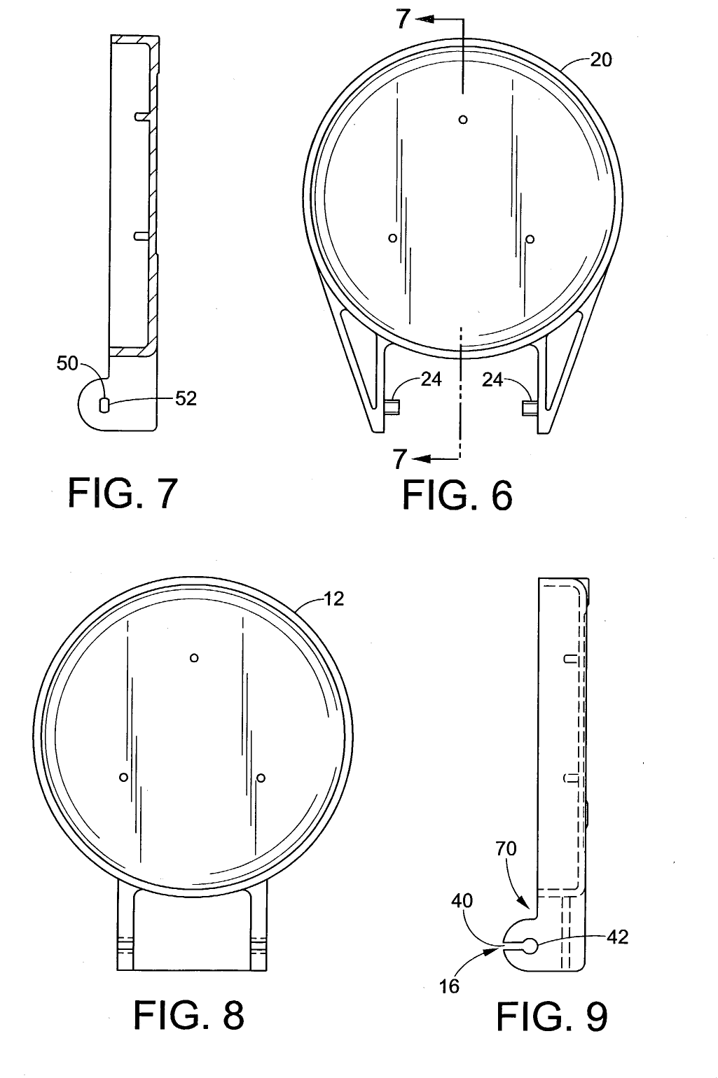

With reference to FIG. 9, it can be seen that the pivot pin holding area 16 is configured as a keyhole slot having an open end and a closed end. The open end has a lesser width 40 defining an opening to the pivot pin holding area for ingress and egress of the pivot pin therein. The closed end 42 has a dimension to accommodate a holding rotation of the pivot pin therein. The pivot pin (FIGS. 6 and 7) has a rectangular cross-sectional configuration including a short side 50 and a long side 52. The short side 50 is sized to accommodate the ingress and egress of the pivot pin in and out of the open end 40 of the pivot pin holding area. The long side 52 is sized to hold the pivot pin 24 within the closed end 42 of the pivot pin holding area at positions of rotation other than the preselected position for detachment (FIG. 4).

As can be best seen in FIG. 4, the short side 50 will slide out through the open end 40 at a ninety degree relative rotational position to allow the discs 12, 20 to be detached from one another.

The hinge assembly 14 is preferably comprised of first and second pivot pins spaced from the food item holding area of the second half shell 20 in the manner that is shown in FIG. 6. The first and second pivot pin holding areas are similarly spaced for receiving the pins as illustrated in FIG. 8 while allowing the discs 12, 20 to overlap and mate in the manner of a closed claim shell. Although the holding areas 13, 21 are generally shown as circular cup configurations sized to accommodate a generally common bagel size, it is within the scope of the invention to configure the holding areas in different shapes, depths and dimensions to accommodate other types of food items. Although it should be known that such other types of food items are those that normally would be intended to be sliced through a spacing 60 (FIG. 3) when held in the assembly. Such a special spacing 60 is defined by the relative hinge dimensions and the pivot pin axis of rotation, as well as the dimensions of the contained food item therein to provide more control and safety for the cutting operation. However, it should be appreciated that the hinge assembly provides a wide selection for the relative orientation between the top and bottom plates when containing the food item. In other words, the spacing 62 closest to the hinge assembly will never completely close so that a slicing tool may be disposed therein while the spacing 60 at the opposite end of the half shells may be other than the spacing 62 and still provide a safe and accurate cutting guide for the slicing operation. To accomplish this objective, it can be seen that the axis of rotation 64 of the pivot pin is disposed at a position approximately half way between the extent of the spacing 62 between the first and second half shells and along the intended slicing line. In addition, as can be appreciated by reference to FIGS. 7 and 9, additional space, generally designated 70, between the hinge assembly 14 and the holding areas is provided to accommodate removal of the slicing tool within the assembly after the slicing operation when the assembly is closed in the FIG. 3 position. The slicing operation thus would occur in a direction beginning at opposite of the hinge assembly and moving towards it.

A gripping area 72 (FIG. 2) between the pivot pins holding areas 16 on the first half shell 12 is large enough to provide an easy and stable grip for a single hand of a user so that the user can press the shells together to hold the item, while the other hand controls the slicing knife. The gripping area and hinge assembly also guard against the knife accidentally slipping through to cut the gripping hand. Thus, this convenient slicing operation guides the knife along a proper cutting path through the bagel while safely protecting the user's hand, and all the while sanitarily holding the bagel in a safe plate assembly. Of course, if the spacing 60 is such when the food item is contained in the assembly to allow the slicing operation to occur in an opposite direction, this is also permissible. In both situations, the assembly provides for controlled direction of the slicing tool through the assembly. In the preferred embodiment the half shells are formed of a hard plastic material, such as Ultem® , a plastic that is microwaveable and dishwasher safe. In the preferred embodiment, the half shells are separated for dishwasher cleaning.

The invention is described with reference to preferred embodiments. Obviously modifications and alterations will occur to others upon an appreciation and understanding of this specification and drawings.

Having thus described the invention, I now claim:

1. A hinged plate assembly for holding a sliceable food item, such as a bagel, in a selected position to facilitate a safe slicing operation, the assembly comprising:
a first half shell comprising a first holding area for the item and a first portion of a hinge assembly including a pivot pin holding slot depending therefrom;
a second half shell comprising a second holding area for the item and a second portion of the hinge assembly including a pivot pin depending therefrom;
wherein the a pivot pin holding slot is dimensioned to selectively receive or remove the pivot pin from the pivot pin holding slot and wherein the pin may rotate in the holding slot through at least one hundred eighty degrees of rotation for effectively closing the first and second half shells to a first position to hold the food item, and opening the first and second half shells to a second position wherein the half shells may be relatively flat as adjacent plates, each holding a part of a sliced food item, the first and second positions comprising a locked holding of the pivot pin in the pivot pin holding area, and wherein to selectively remove the pivot pin from the pivot pin holding slot, thereby allowing detachment of the half shells, the pin may rotate to a preselected position wherein the pivot pin may be removed from the pivot pin holding area.

2. The plate assembly of claim 1 wherein the pivot pin has an axis of rotation disposed relative to the half shells to define a spacing between the half shells to accommodate a slicing tool when closed to the first position.

3. The plate assembly of claim 1 wherein the pivot pin comprises a projection having a long side and a short side, the long side being dimensioned to hold the pivot pin within the pivot pin holding area in the degrees of rotation corresponding to other than the preselected position, and the short side being dimensioned to allow the pivot pin to slide out of the pivot pin holding area when the degree of rotation corresponds to the preselected position.

4. The plate assembly of claim 1 further including a stabilizing prong extending from at least one of the first or second half shells to better secure the food item in the plate assembly for the slicing operation.

5. The plate assembly of claim 1 including support tabs on outer surfaces of the half shells for providing flat support surfaces to the half shells when disposed in the second position.

6. The plate assembly of claim 1 wherein the first and second half shells are disposed as a cup configuration for containing the food item.

7. The plate assembly of claim 1 wherein the pivot pin holding area is configured as a key hole slot having an open end and closed end, the open end having a lesser width defining an opening to the pivot pin holding area for ingress and egress of the pivot pin therein, and the closed end having a dimension to accommodate holding rotation of the pivot pin therein.

8. The plate assembly of claim 7 wherein the pivot pin has a rectangular configuration including a short side and a long side, the short side being sized to accommodate the ingress and egress of the pivot pin from the open end of the pivot pin holding area, the long side being sized to hold the pivot pin within the closed end of the pivot pin holding area at positions of rotation other than the preselected position.

9. The plate assembly of claim 7 wherein the hinge assembly comprises first and second pivot pins disposed for reception in corresponding first and second pivot pin holding areas.
